(19) United States
(12) Patent Application Publication
(10) Pub. No.: US 2004/0266360 A1
(43) Pub. Date: Dec. 30, 2004

(54) Adaptive transceiver system

(76) Inventors: Jyri Hamalainen, Oulu (FI); Kari J Leppanen, Helsinki (FI); Pekka A Ranta, Nummela (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/490,044

(22) PCT Filed: Sep. 19, 2001
(86) PCT No.: PCT/IB01/01948

(51) Int. Cl. H04B 17/00

(52) U.S. Cl. 455/67.16; 455/67.11; 455/67.13

(57) ABSTRACT

A method for forming signals at a transceiver having at least two transmit and receive chain, the method comprising the steps of: (a) determining the phase difference and relative amplitude of signals from a set comprising a plurality of mobile stations as received through the receive chains, (b) receiving from each of at least one of the mobile stations messages indicative of the strength or quality of signals as received by the respective mobile station from the transceiver and on the basis of those messages determining a phase offset and amplitude distortion, internal to the transceiver, resulting from the differences in the instrumental properties of the receiver and transmitter chains in the transceiver; and (c) transmitting signals from each of the transmitter chains by applying to each transmitter chain amplitude weights and signal delays, selected on the basis of the determined phase offset and amplitude distortion, and received relative amplitudes and phase differences.

This invention relates to an adaptive transceiver system. The system is suitably capable of determining transmit weights for multiple transmission chains in accordance with characteristics of received signals when instrumental errors are present.

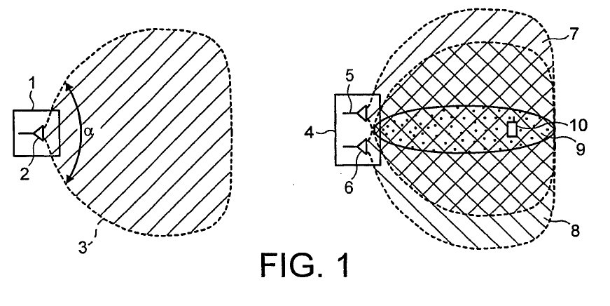

In FIG. 1 the principle behind a beamforming antenna system is illustrated. Transmitter 1 is a conventional transmitter. It transmits a radio signal from an antenna 2. The general pattern of the transmitted signal is a lobe shown at 3. Typically the width α of the transmitted beam covers the whole, typically 120° wide, sector. Transmitter 4 is a beamforming transmitter. It includes two antennas 5, 6 each of which transmits signals over a similar lobe 7, 8 covering the whole sector. In the beamforming transmitter the same signal is transmitted from each antenna 5, 6, but the relative phase of the signals is selected so that the signals interfere constructively over a relatively narrow beam 9. By controlling the relative phase and amplitudes of the signals the beam of constructive interference can be directed towards a desired receiver 10. It is emphasized that beamforming provides just an example of adaptive transceiver systems.

In situations where transmitted signals are intended for a single receiver, adaptive systems such as beamforming have significant potential advantages over conventional transmitter systems. Since a greater proportion of the transmitted energy is offered to the receiver, an adaptive system demands less total transmitted power, and causes less interference to other receivers.

One situation in which adaptive antennas could be particularly useful is mobile phone systems. Mobile phone basestations transmit signals that are directed to individual mobile terminals. Reducing transmitted power and interference is especially desirable in mobile phone systems because a reduction in expected interference would mean higher network capacity. However, a major difficulty in the implementation of adaptive transmitters at the basestations of mobile phone systems is the calculation of the relative phase and amplitudes of the signals that must be transmitted from the antennas so as to adapt the transmission to a desired mobile station.

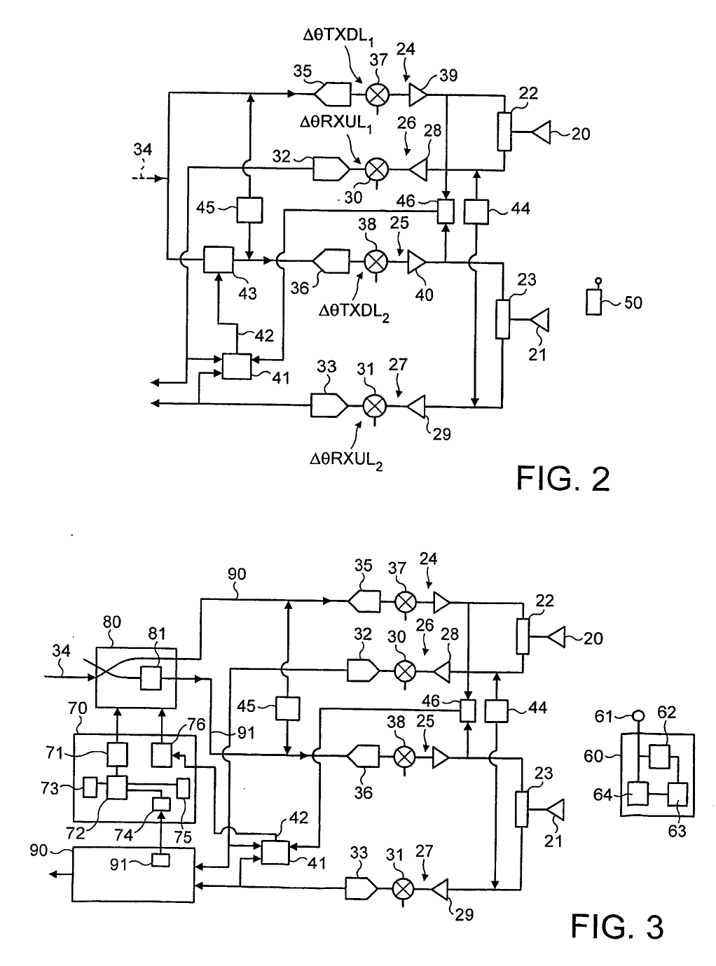

As an example of adaptive antennas, in FIG. 2 a beamforiming basestation for a mobile phone system is considered. The basestation includes a pair of antennas 20, 21. Each antenna is connected via a duplexer 22, 23 to a transmit chain 24, 25 and a receive chain 26, 27. The receive chains include a low noise amplifier 28, 29 and a mixer 30, 31 for downconverting the received signal to baseband. In practice two or more downconversion and amplification stages may be employed. The baseband signals are converted to digital form by A-to-D converters 32, 33 for further processing. In the transmission sections a signal for transmission is generated in digital form at 34. The signal is split to the two antennas and converted to analogue by D-to-A converters 35, 36. In the transmit chains the analogue signals for transmission are upconverted by mixers 37,38 and amplified by amplifiers 39, 40 before being applied to the respective antenna via the duplexers 22, 23. It is noted that in order to keep this example simple only phase control has been considered in FIG. 2. This do not, however, mean that amplitude control would not be applicable. A phase control unit 41 determines the phase offset required to direct a beam to a desired mobile station. The phase control unit forms a phase control signal 42 which is applied to control a phase control unit 43 located in one branch of the digital input. The delay unit inserts a phase offset to antenna 21 so as to cause a phase offset between the signals transmitted from the antennas.

To direct the beam towards a desired mobile station 50 the direction of arrival (DoA) is first estimated by using the signal received from the mobile station and then adjusting the phase offset between the transmission antennas in such a way that a beam is generated in the measured DoA. With two reception antennas the DoA can be estimated from the true phase difference in the signals received from the mobile station by the antennas. However, due especially to imperfections in manufacture of the components of the receive chains 26, 27, to temperature effects and to differences in cable lengths, the measured phase difference and true phase difference differs as the receive chains introduce an additional phase offset into the received signals. Similarly, the measured amplitudes in baseband and true amplitudes are different for both receiving and transmitting chains.

In the following discussion the calibration problems relating to the phase shift and amplitude distortion are explained. To account for the above-mentioned errors the basestation is actively calibrated either continuously or at frequent intervals. In the example of FIG. 2 the calibration is done by injecting a calibration signal into the receive chains from a signal generator 45 and measuring at the control unit 46 the delay introduced into the signal by the receive chains. This yields phase delays θ_{RX1} for receive (uplink) chain 26 and θ_{RX2} for receive chain 27. A similar process is applied to the transmit chain using signal generator 44 and phase determination unit 41 to yield delays θ_{TX1} for transmit (downlink) chain 24 and θ_{TX2} for transmit chain 25. With this information the control unit can calculate the errors introduced due to differences between the receive and transmit chains: Δθ_{RX} and Δθ_{TX}, by:

Δθ_{RX}=θ_{RX1}−θ_{RX2}

and

Δθ_{TX}=θ_{TX1}−θ_{TX2}

Here Δθ_{RX} gives the relationship between the true phase difference of the two antennas Δφ_{RX,TRUE} and the respective phase difference measured at the baseband Δφ_{RX,BB:}

Δφ_{RX,TRUE=}Δφ_{RX,BB+}Δφ_{RX.}

Typically, in beamforming systems Δφ_{RX,TRUE} is used to estimate the DoA for the respective mobile terminal. Similarly, Δθ_{TX} ties together the phase difference that is imposed

on the signal at baseband Δφ_{TX,BB} and the resulting true phase difference Δφ_{TX,TRUE} when the signals leave the antennas, and is given by

Δφ_{TX,TRUE=}Δφ_{TX,BB+}Δθ_{TX.}

In beamforming, the value of Δφ_{TX,TRUE} determines in which direction a beam is formed. Typically, both Δθ_{TX} and Δθ_{RX} need to be separately measured by a calibration system in order to base downlink transmission on the uplink measurements.

Consider next the calibration problem corresponding to the amplitude weighting. In the receiver chain the following relationships between the true signal amplitudes α_{RX1,TRUE}, α_{RX2,TRUE} in antennas and the measured signal gains α_{RX1,BB}, α_{RX2,BB} in baseband are given,

α_{RX1,TRUE}=β_{RX1}·α_{RX1,BB}

α_{RX2,TRUE}=β_{RX2}·α_{RX2,BB}

Here β_{RX1} and β_{RX2} represent the distortion caused by instrumental differences in separate receiver chains. The similar equations are valid also for separate transmit chains. Thus,

α_{TX1,TRUE}=β_{TX1}·α_{TX1,BB}

α_{TX2,TRUE}=β_{TX2}·α_{TX2,BB}

However, in calibration of two-antenna system it is enough to control the relative gain between separate transmit chains. For that purpose we write

$$\frac{{α}_{RX 1 , TRUE}}{{α}_{RX 2 , TRUE}} = {β}_{RX} \cdot \frac{{α}_{RX 1 , BB}}{{α}_{RX 2 , BB}} , {β}_{RX} = \frac{{β}_{RX 1}}{{β}_{RX 2}}$$

$$\frac{{α}_{TX 1 , TRUE}}{{α}_{TX 2 , TRUE}} = {β}_{TX} \cdot \frac{{α}_{TX 1 , BB}}{{α}_{TX 2 , BB}} , {β}_{TX} = \frac{{β}_{TX 1}}{{β}_{TX 2}}$$

where β_{RX} and β_{TX} represent the distortions of relative amplitudes in antennas (true value) and baseband. In prior art systems both β_{RX} and β_{TX} need to be found. Typically this is done by using reference signals which are received from the calibration transmitter and, on the other hand, sent to the calibration receiver.

The complexity of the above-mentioned calibration methods, and the need for frequent calibration of the system makes it costly and clearly more difficult to implement in a practical basestation which employs adaptive antennas. Furthermore, in practice measuring the required phase offsets and amplitude distortions is complicated by the fact that a basestation must be able to communicate with a large number of mobile stations at the same time, which requires that the measurement must not interfere with the normal base station operation.

An alternative system for phase adjustments is described in WO 99/09677. In that system the power or signal quality reported by each mobile station with which the base station is in communication is monitored and used to adjust the transmission phase offset Δφ_{TX,BB} for that mobile station only. In order to operate properly this requires frequent feedback from the mobile station to compensate for the change of feasible phase offset. However, in the GSM system, for example, the feedback rate is only two messages per second which results in slow convergence of the tracking algorithm and limited ability to track the phase offset corresponding to a fast moving mobile terminal. There is therefore a need for an improved adaptive transmitter system.

According to one aspect of the present invention there is provided a method for forming signals at a transceiver having at least two transmit and receive chains, the method comprising the steps of

(a) determining the phase difference and relative amplitude of signals from a plurality of mobile stations as received through the receive chains,

(b) receiving from each of at least some of the mobile stations messages indicative of the strength or quality of signals as received by the respective mobile station from the transceiver and on the basis of those messages determining a phase offset and amplitude distortion, internal to the transceiver, resulting from the differences in the instrumental properties of the receiver and transmitter chains in the transceiver,

(c) transmitting signals from each of the transmitter chains by applying to each transmitter chain amplitude weights and signal delays, selected on the basis of the determined phase offset and amplitude distortion, and received relative amplitudes and phase differences.

The present invention preferably provides a method for determining effectively transmit weights that take into account the instrumental differences of the receiver and transmitter chains.

According to a second aspect of the invention there is provided an apparatus comprising:

reception means for determining the relative amplitudes and phase differences of the signals received at separate antenna branches from at least one of the mobile stations;

means for receiving at the transceiver reporting messages from a set comprising at least one of the mobile stations, the messages being indicative of the strength or quality of signals received by the or each mobile stations of the set from the transceiver and on the basis of those messages determining a phase offset and distortion of the relative amplitude, internal to the transceiver, resulting from the differences in instrumental properties of the receiver and transmitter chains in the transceiver;

transmitting means for applying the amplitude weights and phase differences, selected on the basis of:

(a) the determined phase offset and distortion of the relative amplitude, internal to the transceiver,

(b) the received relative amplitudes and phase differences determined in the receiver section of the transceiver independently for each mobile,

when transmitting signals from separate antenna branches to at least one of the mobile stations

According to a third aspect of the present invention there is provided a method for transmitting signals to a plurality of mobile stations by means of a transceiver having at least two transceiver sections for transmitting and receiving signals and each including an antenna, the mobile stations being capable of transmitting to the transceiver reporting messages indicative of the strength or quality of signals received by the terminals from the transceiver; the method comprising: receiving at the transceiver reporting messages from a set comprising at least one of the mobile stations, the messages being indicative of the strength or quality of signals received by the or each mobile station of the set from the transceiver and on the basis of those messages determining a phase offset and distortion of the relative amplitude, values representing a phase offset and distortion of the relative amplitude, internal to the transceiver; comparing signals received from another of the mobile stations by means of the first transceiver section with signals received from the other mobile station by means of the second transceiver section and thereby determining values of a phase difference and relative amplitude representing a phase offset and relative amplitude due to the relative connection between the transceiver and the other mobile station; forming a signal for transmission to the other mobile station; and transmitting the signal by applying the signal to the first transceiver section, and to the second transceiver section with

(a) a phase shift determined by means of the first phase offset, internal to the transceiver, and the second phase offset corresponding to the respective mobile station,

(b) an amplitude weights determined by mean of the distortion of the relative amplitude, internal to the transceiver, and the relative amplitude corresponding to the respective mobile station.

According to a fourth aspect of the present invention there is provided a transceiver for transmitting signals to a plurality of mobile stations, the mobile stations being capable of transmitting to the transceiver reporting messages indicative of the strength or quality of signals received by the terminals from the transceiver, and the transceiver comprising: at least two transceiver sections for transmitting and receiving signals and each including an antenna, the mobile stations being capable of transmitting to the transceiver reporting messages indicative of the strength or quality of signals received by the terminals from the transceiver; a first phase offset and distortion of the relative amplitude determination means arranged to receive reporting messages from a set comprising at least one of the mobile stations, the messages being indicative of the strength or quality of signals received by the or each mobile station of the set from the transceiver and on the basis of those messages determining values of a first phase offset and distortion of the relative amplitude representing a phase offset and distortion of the relative amplitude, internal to the transceiver; a second phase offset and relative amplitude determination means arranged to compare signals received from another of the mobile stations by means of the first transceiver section with signals received from the other mobile station by means of the second transceiver section and thereby determining a second phase offset value and relative amplitude representing a phase offset and relative amplitude due to the relative connection between the transceiver and the other mobile station; a phase shifting and amplitude weighting units for applying a phase shift and amplitude weights of values determined by means of the first phase offset and distortion of the relative amplitude, and the second phase offset and relative amplitude; and a signal former for forming a first signal for transmission to the other mobile station and connected to the first transceiver section to apply the first signal to the first transceiver section for transmission and via the phase shifting and amplitude weighting units to the second transceiver section to apply a phase shifted and amplitude weighted version of the first signal to the second transceiver section for transmission.

Embodiments of these aspects of the invention are preferably able to simultaneously determine and compensate the phase offset and amplitude distortion, internal to the transceiver, and select the feasible transmit weights on the basis of the received signals.

The set suitably comprises a plurality of mobile stations, conveniently all the mobile stations currently attached to and/or communicating with the transceiver. The set preferably comprises the said other mobile station.

The values of the first phase offset and distortion of the relative amplitude are preferably determined by iteratively adjusting previous values of the first phase offset and distortion of the relative amplitude in a direction so as to maximise the average signal strength or quality reported by the mobile station(s) of the set. For this purpose the method may comprise transmitting signals to the mobile stations of the set, each signal being transmitted by means of the values of the first phase offset and distortion of the relative amplitude, and a respective second phase offset and relative amplitude corresponding to the respective mobile station; storing a first representation of the average reported signal strength or quality; adjusting the first phase offset and distortion of the relative amplitude; transmitting signals to the mobile stations of the set, each signal being transmitted by means of the adjusted first phase offset and distortion of the relative amplitude, and a respective second phase offset and relative amplitude corresponding to the respective mobile station; and comparing the subsequent average reported signal strength or quality with the first representation of the average reported signal strength or quality.

The method suitably comprises the steps of comparing signals received from each of the mobile stations of the set by means of the first transceiver section with signals received from the same mobile station by means of the second transceiver section and thereby determining a second phase offset value and relative amplitude corresponding to that mobile station; forming first signals for transmission to the mobile stations of the set; transmitting each of the first signals by applying them to the first transceiver section, and to the second transceiver section with a phase shift amplitude weights determined by means of the first phase offset and distortion of the relative amplitude, and the second phase offset and relative amplitude corresponding to the respective mobile station.

The signal strength or qualities reported by each of the mobile stations of the set are suitably reported in response to the transmission of signals to the respective mobile station by means of the second phase offset and relative amplitude corresponding to the respective mobile station.

The transceiver may be a basestation. The basestation may be operative to adjust the power with which it transmits signals to the mobile stations on the basis of the signal strengths and qualities reported by that mobile station. The messages may be power control messages.

At least some of the mobile stations may be mobile telephones. The mobile stations need not actually be mobile; at least some may be fixed in location.

The second phase offset(s) may be dependent on the relative orientation of the antennas and the respective mobile station.

The phase shift is suitably determined as the sum of the first and second phase offsets, or the difference between the first and second phase offsets.

The relative amplitude may be dependent on the relative orientation of the antennas and the respective mobile station.

The relative amplitude is suitably determined as the multiplication of the distortion of the relative amplitude and received relative amplitude.

FIG. 1 illustrates conventional and beamforming transmitter systems;

FIG. 2 shows the structure of an example beamforming basestation;

FIG. 3 shows the structure of an example beamforming basestation and a mobile station capable of implementing the present invention

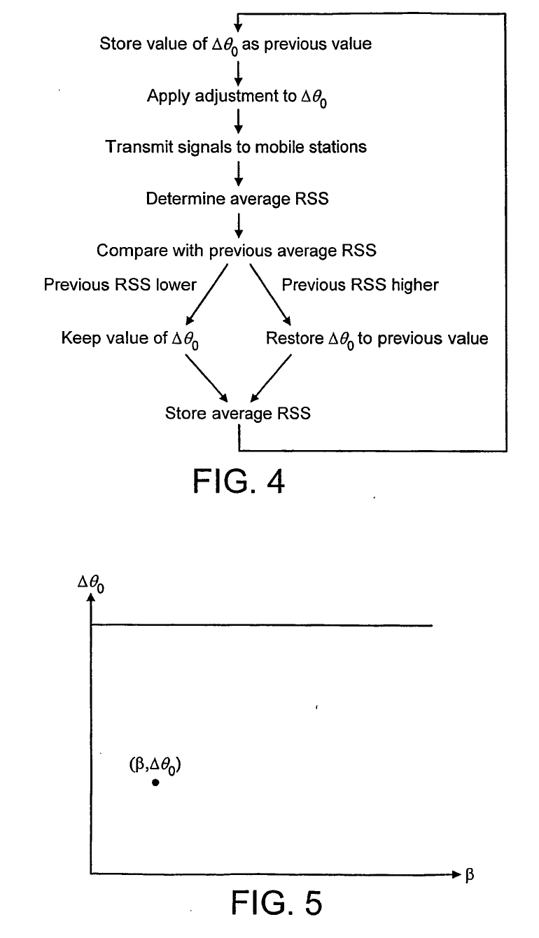

FIG. 4 is a flow diagram illustrating an algorithm for performing a method for setting the value of phase offset Δθ_{O} or distortion β of the relative amplitude; and

FIG. 5 shows the parameter space from which the values of phase offset Δθ_{O} and relative distortion β of the amplitude are searched.

The inventors of the present invention have observed that even if beamforming is employed, the absolute DoA (direction of arrival) has little importance for directing the transmission beam into the direction of the mobile terminal. Instead of concentrating on indirect measures such as DoA in beamforming, we may require that the following conditions are satisfied:

$${Δφ}_{TX , TRUE} = {Δφ}_{RX , TRUE} , \frac{{α}_{TX 1 , TRUE}}{{α}_{TX 2 , TRUE}} = \frac{{α}_{RX 1 , TRUE}}{{α}_{RX 2 , TRUE}} .$$

Hence, only the phase difference and relative amplitude between signals from separate antenna branches form the basis for transmission. Disregarding the small phase error that is caused by the frequency difference between uplink and downlink (especially true when the distance between the antenna elements is small), we may say that, with adequate accuracy, satisfying these conditions will lead to adaptation of downlink transmission to uplink measurements. It should be noted that as part of this invention suitable time averaging can be applied to obtain the measured parameters and that the above condition can be fulfilled on average over any appropriate period of time. It follows that

$${Δφ}_{TX , BB} + {Δθ}_{TX} = {Δφ}_{RX , BB} + Δ {θ}_{RX} , {β}_{TX} \cdot \frac{{α}_{TX 1 , BB}}{{α}_{TX 2 , BB}} = {β}_{RX} \cdot \frac{{α}_{RX 1 , BB}}{{α}_{RX 2 , BB}}$$

and the phase difference and the relative amplitude to be used at the baseband can be obtained from

$${Δφ}_{TX , BB} = {Δφ}_{RX , BB} + {Δθ}_{O} , \frac{{α}_{TX 1 , BB}}{{α}_{TX 2 , BB}} = β \cdot \frac{{α}_{RX 1 , BB}}{{α}_{RX 2 , BB}} , where$$

$${Δθ}_{O} = {Δθ}_{RX} - {Δθ}_{TX} , β = \frac{{β}_{RX}}{{β}_{TX}} .$$

A second observation is that the phase offset Δθ_{O} and the distortion β of the relative amplitude are purely instrumental quantities (intrinsic to the related transceiver pair) that change slowly in time, and importantly, are the same for all mobile stations being served by this transceiver pair. If Δθ_{O} and β are determined and tracked by using any mobile station or stations, they can be used to adapt the downlink transmission for any mobile station simply by measuring the phase difference Δφ_{RX,BB} and relative gain α_{RX1,BB}/α_{RX2,BB} in uplink for that mobile station and applying the values of Δφ_{O} and β to obtain the values Δφ_{TX,BB} and α_{TX1,BB}/α_{TX2,BB} to be used for that mobile station.

A third observation is that Δθ_{O} and β can be determined and tracked by using any mobile station being served by the transceiver pair. For this it is required that the mobile station is capable of transmitting to the transceiver reporting messages indicative of the strength or quality of signals received by the terminals from the transceiver. These messages are used to adjust estimates of the values Δθ_{O} and β in such a way that the true value with adequate accuracy follows.

FIG. 5 shows the parameter space and a certain parameter point (β, Δθ₀). In calibration the aim is to find a point (β, Δθ₀) such that the strength or quality of signals received by mobiles is maximized. It is important to note that (β,Δθ₀) maximize the strength or quality of signals received by mobiles is the same for all mobiles. This two-dimensional optimisation problem can be solved in practice, for example, by reducing it into two consecutive one-dimensional problems. Hence, β is first fixed and best value for Δθ₀ is searched using method proposed in FIG. 4. Then Δθ₀ is fixed and best value for β is searched using method of FIG. 4. This process is continued until feasible values for both Δθ₀ and β are found. It is remarked that the method of FIG. 4 is applicable when best values for both Δθ₀ and β are searched. There exist many possible alternatives how to determine and track Δθ₀ and β which can be implemented within the scope of the present invention.

In FIG. 3 like components are numbered as in FIG. 2.

The basestation of FIG. 3 is a beamforming basestation. The mobile station 60 has an antenna 61, a received signal strength or quality measurement unit 62 coupled to the antenna for measuring the received signal strength (RSS) or quality and reporting it to a control unit 63, and a transmission signal generation unit 64 also coupled to the antenna for generating signals for transmission under the control of the control unit 63. The basestation has a signal strength or quality report processing unit 70 which decodes the signal strength or quality reports received by the base stations and processes them accordingly. Many communication systems require mobile stations to be capable of reporting received signal strength or quality to the basestation. Examples are GSM (Global System for Mobile Communications) and UMTS (Universal Mobile Telecommunications System). The principles behind measurement of received signal strength or quality, encoding signals strength or quality reports at mobile stations and decoding them at the base station are well known.

The system of FIG. 3 uses the assumption that within a small period of time differences in the transmit and receive chains will have the same effect for communications between the base station and all the mobile stations with which it communicates. Thus during that period Δθ_{O} can be assumed to be the same for communications with all mobile stations.

During operation of the system of FIG. 3 a current value of Δθ_{O} is stored by control unit 70. The determination of that value is discussed below. When a signal from a mobile station is received the phase difference Δφ_{RX,BB} between the signals received from that mobile station via the two antennas is determined at control unit 80. A phase difference Δφ_{TX,BB} is applied to signals for transmission to that mobile station. Δφ_{TX,BB} is calculated by:

Δφ_{TX,BB=}Δφ_{RX,BB+}Δθ_{O}

This expression holds for all mobile stations.

Once an initial value of Δθ_{O} has been determined, an iterative process is performed to update the value, initially to improve its accuracy, and then to cope with temperature and other environmental variations. In each step of the iterative process a modification is made to the value of Δθ_{O}. The averages of the reported received signal strengths or qualities from each of the mobile stations to which the base station transmits before and after the modification are compared. If the average is greater after the modification then the modification is taken to have resulted the value of Δθ_{O} more accurately reflecting the differences introduced by the basestation hardware. In that case the modified value of Δθ_{O} is kept as a starting value for the next iteration. Otherwise, Δθ_{O} is restored to its value before modification as the starting value for the next iteration. Other methods could be used to adjust Δθ_{O}.

The iterative process is illustrated in FIG. 4.

FIG. 3 shows details of the components used in the control unit 70 to perform the process. The value of Δθ_{O} is stored in store 71. Store 71 is available to the transmission section 80 of the basestation for forming signals for transmission to mobile stations. A new value of Δθ_{O} is formed in calculation unit 72. The old value of Δθ_{O} is stored in backup store 73 and the new value of Δθ_{O} is stored in store 71. Signals are transmitted to the mobile stations using the value of Δθ_{O} stored in store 71. Measurement reports from mobile stations are detected by a signal monitor 91 in the decoding section 90 of the basestation and passed to an averaging unit 74 which forms an average of the reports received over a predetermined time period. That new average is compared by the controller 72 with the previously determined average which has been stored in store 75. If the new average is greater then the value of Δθ_{O} stored in store 71 is left unchanged. Otherwise, the value of Δθ_{O} is restored to the old value of Δθ_{O} as stored in backup store 73. The newly determined average is then loaded into store 75 for use in the next iteration.

The control unit 70 also includes a set of stores 76 each of which stores the value of Δφ_{RX,BB} for a respective mobile station. The stores 76 are accessible to the transmission unit 80 for use in forming transmissions to the mobile stations.

In forming a transmission to a mobile station the transmission unit 80 receives a signal for transmission at 34. It applies that signal to the transmission input 90 of the first transceiver unit 24, 26 etc. It also applies the signal from phase shifter 81 to the transmission input 91 of the second transceiver unit 24, 26 etc. The phase shift applied by the phase shifter 81 is determined as described above using the value of Δθ_{O} derived from store 71 and the appropriate value of Δφ_{RX,BB} derived from store 76. The appropriate value of Δφ_{RX,BB} is the value of Δφ_{RX,BB} for the mobile station to which the signal is to be directed. The identity of that mobile station may be determined by the transmission unit 80 from the content of the signal itself, or from a separate signal it receives.

Conveniently, the RSS is reported by the mobile stations according to the normal means as required by the standard to which they operate. Thus GSM mobile stations will typically provide reports of RSS around twice each second, whereas UMTS mobile stations will typically provide very frequent reporting. If the RSS reports are very frequent then it may be preferable to average them over time in order to remove the effect of fast fades.

In order to determine the average RSS for use in refining the value of Δθ_{O} the base station could use RSS reports from all of the mobile stations that report to the base station on the power received from that base station (all the mobile stations connected to that base station). Alternatively, just a subset of those mobile stations could be used in order to make the process of determining the average RSS quicker. Reports from a single mobile station could be used if desired.

In order to determine whether the average RSS has risen or fallen as a result of an adjustment of the value of Δθ_{O}, all the reported RSS values could be averaged at each iterative step and the values reported at successive steps compared with each other. Alternatively, the system could determine whether the majority of individual RSS values from each mobile station have resin or fallen as a result of the adjustment. Other schemes could also be used.

When the value of Δθ_{O} that is to be used for communications with all mobile stations is known, it is very straightforward for the basestation to begin beamforming to a mobile station that has newly attached to the basestation. All that is needed is for the control unit 80 to measure the difference in phase between signals received from the base station via the two antennas of the basestation and to use that difference as the value of Δφ_{RX,BB} for communications with that mobile station. In a typical basestation the phase difference can conveniently be measured at baseband. The value of Δφ_{RX,BB} can be measured each time a communication is received from a mobile station, or periodically. The preferred interval for measuring Δφ_{RX,BB} will depend on the width of the beam formed by the antennas, the sensitivity of the mobile station and the expected maximum speed of the mobile station. The measured value of Δφ_{RX,BB} may be averaged over a short timebase to give a working value of Δφ_{RX,BB}. The control unit 80 conveniently stores values of Δφ_{RX,BB} to be used for communications with each mobile station attached to the base station so that signals can be beamformed to the mobile stations with little delay.

Using the same value of Δθ_{O} for communications with all mobile stations may be expected to involve some additional error over a system in which individual values of Δθ_{O} are used for each mobile station, due to differences in frequency between the transmit and receive signals and due to differences between the signals to and from the different mobile stations. Since there is a spacing between the two antennas the path lengths between a mobile station and each antenna will normally be different and there will be therefore be a frequency-related component in the phase offset as received at the antennas. However, in most systems the relative frequency difference between uplink and downlink signals will be small—typically less than 10%. Therefore, the beamforming capability of a system as described above is unlikely to be hindered significantly by those errors. In addition, error can be reduced by closer spacing of the antennas; preferably the antennas are set at a spacing of 1/2λ, where λ is the typical wavelength at which the system is to operate.

When the process described above is initiated, an initial value of Δθ_{O} must be selected. The initial value of Δθ_{O} may be preset in the base station, determined randomly or determined by internal calibration using signal generators 44, 45 in the base station as discussed above with reference to FIG. 2 and using the equation Δθ_{O}=Δθ_{RX}−Δθ_{TX}.

The modification of the value of Δθ_{O} at each iteration may be performed according to standard techniques for iterative optimisation of feedback parameters. For example, at each iteration a predetermined small offset δ could be applied to the starting value of Δθ_{O} for that iteration. δ could be added or subtracted in alternate iterations, or could be applied with the same sign as in the previous iteration if the previous iteration resulted in a change in the value of Δθ_{O} or with the opposite sign if the previous iteration resulted in the value of Δθ_{O} remaining unchanged.

The present invention may be applied to any adaptive transceiver systems that use co-polarisation antennas or that use antennas of different polarisation.

The present invention may be applied to systems that transmit using more than two antennas. In such a case the phase differences caused by the transmit and receive chains associated with one antenna and those associated with each other antenna should be determined. This can still be done using an iterative process based on the average reported RSS.

The mobile station could be a mobile phone. The mobile station need not actually be mobile: it could be fixed in location. The mobile station may be termed a terminal.

The basestation and the mobile station are suitable operable according to any suitable protocol, for example GSM, UMTS (3G) or a derivative thereof.

The applicant draws attention to the fact that the present inventions may include any feature or combination of features disclosed herein either implicitly or explicitly or any generalisation thereof, without limitation to the scope of any definitions set out above.

In view of the foregoing description it will be evident to a person skilled in the art that various modifications may be made within the scope of the inventions.

1. A method for forming signals at a transceiver having at least two transmit and receive chains, the method comprising the steps of:
(a) determining the phase difference and relative amplitude of signals from a set comprising a plurality of mobile stations as received through the receive chains,
(b) receiving from each of at least one of the mobile stations messages indicative of the strength or quality of signals as received by the respective mobile station from the transceiver and on the basis of those messages determining a phase offset and amplitude distortion, internal to the transceiver, resulting from the differences in the instrumental properties of the receiver and transmitter chains in the transceiver; and
(c) transmitting signals from each of the transmitter chains by applying to each transmitter chain amplitude weights and signal delays, selected on the basis of the determined phase offset and amplitude distortion, and received relative amplitudes and phase differences.

2. An apparatus comprising:
reception means for determining the relative amplitudes and phase differences of the signals received at separate antenna branches from at least one of the mobile stations;
means for receiving at the transceiver reporting messages from a set comprising at least one of the mobile stations, the messages being indicative of the strength or quality of signals received by the or each mobile stations of the set from the transceiver and on the basis of those messages determining a phase offset and distortion of the relative amplitude, internal to the transceiver, resulting from the differences in instrumental properties of the receiver and transmitter chains in the transceiver;
transmitting means for applying the amplitude weights and phase differences, selected on the basis of:
(a) the determined phase offset and distortion of the relative amplitude, internal to the transceiver,
(b) the received relative amplitudes and phase differences determined in the receiver section of the transceiver independently for each mobile,
when transmitting signals from separate antenna branches to at least one of the mobile stations.

3. A method for transmitting signals to a plurality of mobile stations by means of a transceiver having at least two transceiver sections for transmitting and receiving signals and each including an antenna, the mobile stations being capable of transmitting to the transceiver reporting messages indicative of the strength or quality of signals received by the terminals from the transceiver; the method comprising:
determining the relative amplitudes and phase differences of the signals received at separate antenna branches from at least one of the mobile stations.
receiving at the transceiver reporting messages from a set comprising at least one of the mobile stations, the messages being indicative of the strength or quality of signals received by the or each mobile stations of the set from the transceiver and on the basis of those messages estimating a phase offset and a change of relative amplitude, internal to the transceiver, resulting from the differences in instrumental properties of the receiver and transmitter chains in the transceiver;
applying to signals to be transmitted from separate antenna branches to at least one of the mobile stations amplitude weights and signal delays, selected on the basis of the
(a) phase offset and distortion of the relative amplitude, internal to the transceiver,
(b) received relative amplitudes and phase differences determined in the receiver section of the transceiver.

4. A method as claimed in claim 3, wherein the set comprises a plurality of mobile stations.

5. A method as claimed in claim 1, wherein the set comprises all the mobile stations currently attached to the transceiver.

6. A method as claimed in claim 3, wherein the set comprises the said other mobile station.

7. A method as claimed in claim 1, wherein the values of the phase offset and distortion of the relative amplitude, internal to the transceiver, are determined by iteratively adjusting a previous value of the phase offset and amplitude distortion so as to maximise the average signal strength or quality reported by the mobile station(s) of the set.

8. A method as claimed in claim 6, comprising the steps of:
comparing signals received from each of the mobile stations of the set by means of the first transceiver section with signals received from the same mobile station by means of the second transceiver section and thereby determining a phase difference corresponding to that mobile station;
comparing signals received from each of the mobile stations of the set by means of the first transceiver section with signals received from the same mobile station by means of the second transceiver section and thereby determining a relative amplitude between receiver sections corresponding to that mobile station;
forming first signals for transmission to the mobile stations of the set;
transmitting each of the first signals by applying them to the first transceiver section, and to the second transceiver section with
(a) a phase shift determined by means of the first phase offset, internal to the transceiver, and the second phase offset corresponding to the respective mobile station,
(b) an amplitude weight determined by mean of the distortion of the relative amplitude, internal to the transceiver, and the relative amplitude corresponding to the respective mobile station.

9. A method as claimed in claim 8, wherein the signal strengths or qualities reported by each of the mobile stations of the set are reported in response to the transmission of signals to the respective mobile station by means of the second phase offset and relative amplitude corresponding to the respective mobile station.

10. A method as claimed in claim 1, wherein the amplitude weights are neither determined nor used.

11. A method as claimed in claim 1, wherein co-polarized antennas are used for transmission of signals by the transceiver.

12. A method as claimed in claim 1, wherein cross-polarized antennas are used for transmission of signals by the transceiver.

13. A method as claimed in claim 1, wherein the antennas used for transmission by respective transmit chains of the transceiver are spatially separated.

14. A method as claimed in claim 1, wherein the transceiver is a basestation.

15. A method as claimed in claim 14, wherein the basestation is operative to adjust the power with which it transmits signals to the mobile stations on the basis of the signal strengths or qualities reported by that mobile station.

16. A method as claimed in claim 1, wherein at least some of the mobile stations are mobile telephones.

17. A transceiver for transmitting signals to a plurality of mobile stations, the mobile stations being capable of transmitting to the transceiver reporting messages indicative of the strength or quality of signals received by the terminals from the transceiver, and the transceiver comprising:
at least two transceiver sections for transmitting and receiving signals and each including an antenna, the mobile stations being capable of transmitting to the transceiver reporting messages indicative of the strength or quality of signals received by the terminals from the transceiver;
a first phase offset and distortion of the relative amplitude determination means arranged to receive reporting messages from a set comprising at least one of the mobile stations, the messages being indicative of the strength or quality of signals received by the or each mobile station of the set from the transceiver and on the basis of those messages determining a values of the first phase offset and distortion of the relative amplitude representing a phase offset and distortion of the relative amplitude internal to the transceiver;
a second phase offset and relative amplitude determination means arranged to compare signals received from another of the mobile stations by means of the first transceiver section with signals received from the other mobile station by means of the second transceiver section and thereby determining a second phase offset and relative amplitude values representing a phase offset and relative amplitude due to the relative connection between the transceiver and the other mobile station;
a phase shifting and amplitude weighting units for applying a phase shift and amplitude weights of values determined by means of the first phase offset and distortion of the relative amplitude, and the second phase offset and relative amplitude; and
a signal former for forming a first signal for transmission to the other mobile station and connected to the first transceiver section to apply the first signal to the first transceiver section for transmission and via the phase shifting and amplitude weighting units to the second transceiver section to apply a phase shifted and amplitude weighted version of the first signal to the second transceiver section for transmission.
